(19) United States
(12) Patent Application Publication
(10) Pub. No.: US 2013/0069758 A1
(43) Pub. Date: Mar. 21, 2013

(54) INDUCEMENT APPARATUS, METHOD FOR CONTROLLING INDUCEMENT APPARATUS, AND INDUCEMENT SYSTEM

(71) Applicants: Hyun Woo KANG, Daegu (KR); Ho Geun LEE, Daegu (KR); Ji Hye O, Daegu (KR)

(72) Inventors: Hyun Woo KANG, Daegu (KR); Ho Geun LEE, Daegu (KR); Ji Hye O, Daegu (KR)

(73) Assignee: Electronics and Telecommunications Research Institute, Daejeon (KR)

(21) Appl. No.: 13/563,188

(22) Filed: Jul. 31, 2012

(30) Foreign Application Priority Data
Sep. 21, 2011 (KR) 10-2011-0095421

(51) Int. Cl. G08C 17/02

(52) U.S. Cl. 340/1.1

(57) ABSTRACT

Provided are a method of controlling an inducement apparatus, including: changing an output period of a light emitter of the inducement apparatus; dividing the changed output period into a plurality of slots, and generating control information, including the changed output period, as control information for controlling another inducement apparatus in a random slot among the divided plurality of slots; and transmitting the generated control information to the other inducement apparatus, and an inducement apparatus and an inducement system for implementing the method.

### CROSS-REFERENCE TO RELATED APPLICATIONS

This application claims priority to and the benefit of Korean Patent Application No. 10-2011-0095421 filed in the Korean Intellectual Property Office on Sep. 21, 2011, the entire contents of which are incorporated herein by reference.

### TECHNICAL FIELD

The present invention relates to an inducement apparatus, a method of controlling the inducement apparatus, and an inducement system, and more particularly, to an inducement apparatus capable of controlling a light emitter using communication, a method of controlling the light emitter using the communication, a computer-readable recording medium thereof, and an inducement system.

### BACKGROUND ART

An inducement apparatus is an apparatus that is installed on the road to improve driving convenience for a driver while driving at night. In general, while driving at night, the visual field of a driver is limited to a predetermined range according to headlights of a vehicle. It is difficult to obtain information about the road beyond the range of the headlights.

Accordingly, streetlights may be installed on the side of roads. However, street light installation cost is generally significantly high and thus, it is practically difficult to install streetlights on all the roads. Accordingly, in general, an inducement apparatus that uses relatively inexpensive installation cost and maintenance cost is installed.

In the case of a general inducement apparatus, a reflection mirror was used without self-power and eyes of a driver were induced in such a manner that the light is reflected. Therefore, it was impossible to perform control using communication such as the Internet, radio frequency identification (RFID), and the like.

However, a technology of self-charging power using sunlight and technologies enabling a control using wireless communication have been currently developed. As a related art, in the case of a published patent <Korean Patent Application No. 10-2009-060200, “Remote control gaze induction system where the consuming electric power is few”>, individual inducement apparatuses are configured to perform a flickering control operation using a timer embedded in a self-controller. However, there was a problem that flickering synchronization with other inducement apparatuses was not accurately matched.

### SUMMARY OF THE INVENTION

The present invention has been made in an effort to provide a method and an apparatus for performing control using communication when controlling an operation of an inducement apparatus such as a flickering period of the inducement apparatus, a computer-readable recording medium thereof, and an inducement system.

In general, it is impossible for all the inducement apparatuses to directly communicate with each other within the same hop. When an inducement apparatus receives a permission from a radio station to thereby have great transmission power, the inducement apparatus may transmit control information with respect to a relatively far distance. However, when the transmission power is not great, when the transmission power is great, but an installation distance of the inducement apparatus is out of the transmission power range, or when a shadowing area occurs due to winding roads, the inducement apparatus may not transfer control information.

An exemplary embodiment of the present invention provides a method of controlling an inducement apparatus, the method including: changing an output period of a light emitter of the inducement apparatus; dividing the changed output period into a plurality of slots, and generating control information, including the changed output period, as control information for controlling another inducement apparatus in a random slot among the divided plurality of slots; and transmitting the generated control information to the other inducement apparatus.

The changing of the output period of the light emitter may change the output period of the light emitter based on the control information received from the inducement apparatus.

The generating of the control information may include: extracting path information from the received control information; and generating the control information when the extracted path information does not include destination information.

The generating of the control information may include: extracting, from the received control information, a travel path distance from a reference apparatus to an apparatus that has transmitted the received control information; and a conditional information generating step of generating the control information when a path distance from the reference apparatus exceeds the extracted travel path distance.

The changing of the output period of the light emitter based on the received control information may include: determining whether a reception rate of the received control information is less than or equal to a predetermined reference rate; and decreasing a flickering period start time of the received control information by a correction time when the reception rate is less than or equal to the predetermined reference rate.

The generating of the control information may include: determining whether a transmission rate of the eye inducement apparatus is less than or equal to a predetermined reference rate; and decreasing a flickering period start time of the generated control information by a correction time when the transmission rate is less than or equal to the predetermined reference rate.

The received control information may be received by the inducement apparatus using wireless communication.

a period start time of the received control information may be decreased using a correction time by determining a transmission rate and a transmission distance of the wireless communication.

Another exemplary embodiment of the present invention provides an inducement apparatus, including: an output controller to change an output period of a light emitter; a control information generator to divide the changed output period into a plurality of slots, and to generate control information, including the changed output period, as control information for controlling another inducement apparatus in a random slot among the divided plurality of slots; and a control information transmitter to transmit the generated control information to the other inducement apparatus.

The output controller may change the output period of the light emitter based on the received control information.

The control information generator may include: a path information extractor to extract path information from the received control information; and a condition information generator to generate the control information when the extracted path information does not include destination information.

The control information generator may include: a path information extractor to extract, from the received control information, a travel path distance from a reference apparatus to an apparatus that has transmitted the received control information; and a conditional information generator to generate the control information when a path distance from the reference apparatus exceeds the extracted travel path distance.

The output controller may include: a reception rate inspector to inspect a reception rate of the received control information; a control information corrector to decrease a flickering period start time of the received control information by a correction time when the reception rate is less than or equal to a reference rate set by a user; and a period changing unit to change the output period of the light emitter based on control information processed by the control information corrector.

Still another exemplary embodiment of the present invention provides an inducement system, including: a plurality of inducement apparatuses, wherein each of the plurality of inducement apparatuses receives control information, changes an output period of a light emitter based on the received control information, divides the changed output period into a plurality of slots, generates control information, including the changed output period, as control information for controlling another inducement apparatus in a random slot among the divided plurality of slots, and transmits the generated control information to the other inducement apparatus.

Each of the plurality of inducement apparatuses may include: a path extractor to extract path information from the received control information; and an information controller to change the output period of the light emitter based on the received control information when the extracted path information corresponds to a condition set by a user, to divide the changed output period into the plurality of slots, to generate the control information, including the changed output period, as the control information for controlling the other inducement apparatus in the random slot among the divided plurality of slots, and to transmit the generated control information to the other inducement apparatus.

Each of the plurality of inducement apparatuses may further include: a reception rate inspector to inspect a reception rate of the received control information; and a control information corrector to correct at least one period start time of the received control information and the generated control information when the reception rate is less than or equal to a reference rate set by a user.

According to exemplary embodiments of the present invention, it is possible to quickly control an inducement apparatus with respect to all the section of the inducement apparatus, to, at the same time, efficiently flood control information into the overall section, to decrease a data collision probability, and to transfer reliable control information. Since a wireless communication is used, it is possible to enable a control of the inducement apparatus within a short period of time through a relatively small output radio wave and a multi-hop synchronous message transfer method even though at least one hop has an arrival distance of a radio wave.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating a method of controlling an inducement apparatus according to an exemplary embodiment of the present invention.

FIG. 2 is a flowchart illustrating a method of controlling an inducement apparatus considering a reception rate of control information according to an exemplary embodiment of the present invention.

FIG. 3 is a reference diagram illustrating a method of controlling an inducement apparatus according to a related art.

FIG. 4 is a reference diagram to describe a process of performing a method of controlling an inducement apparatus according to an exemplary embodiment of the present invention.

FIG. 5 is a flowchart illustrating a method of controlling an inducement apparatus considering a user setting condition according to an exemplary embodiment of the present invention.

FIG. 6 is a reference diagram to describe a process of performing a method of controlling an inducement apparatus considering multiple hops according to an exemplary embodiment of the present invention.

FIG. 7 is a block diagram illustrating an inducement apparatus according to another exemplary embodiment.

FIG. 8 is a block diagram illustrating an inducement apparatus according to still another exemplary embodiment.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. When it is determined the detailed description related to a related known function or configuration may make the purpose of the present invention unnecessarily ambiguous in describing the present invention, the detailed description will be omitted here.

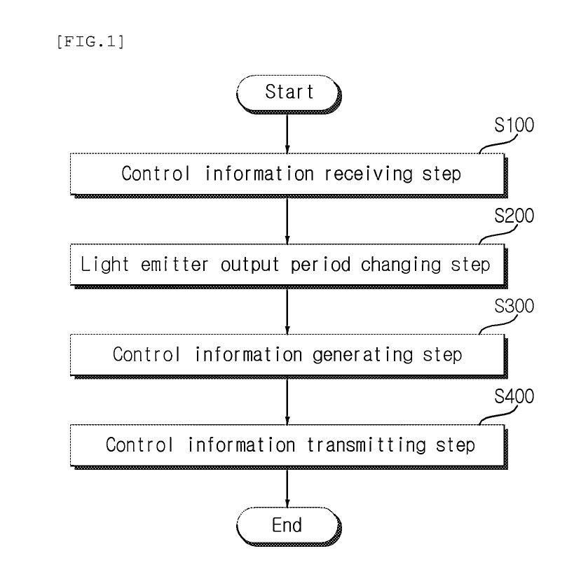

A method of controlling an inducement apparatus according to an exemplary embodiment of the present invention will be described with reference to FIG. 1.

In control information receiving step S100, control information is received from an outside. For example, control information may be received from a control signal generation apparatus, a controller, or another inducement apparatus. The control information indicates information for controlling a setting of the inducement apparatus, and may include period information of the inducement apparatus, a flickering period of a light emitter, a flickering start time, a flickering end time, and information for controlling a luminous level. Also, the control information may include power information of the other inducement apparatus, operation information, path information, distance information from a reference apparatus, routing path information, and identification information such as position information. The reference apparatus is an apparatus that is a reference of a control signal or synchronization, such as the control signal generation apparatus or the inducement apparatus, and may be set by a user.

According to an exemplary embodiment of the present invention, control information may be configured to be received using wireless communication. The method of controlling the inducement apparatus may include a step of determining a transmission rate and a transmission distance of the wireless communication and correcting control information based on the determination result. For example, when the transmission rate of wireless communication is low, or when the transmission distance is far, an amount of time used to receive the control information may be determined to be long and the control information may be corrected based on the transmission distance. A correction method of period information may be arbitrarily set by the user. The period information may be corrected so that all the inducement apparatuses may be synchronized with each other based on period information of control information.

In the present invention, the wireless communication includes all of a radio frequency (RF), radio frequency identification (RFID), and the like, and indicates a configuration capable of transmitting and receiving data using a signal and the like. Also, the wireless communication includes a case where a multi-hop network is formed due to characteristics of a distance constraint of the wireless communication. Accordingly, it is possible to use a protocol capable of synchronizing all the apparatuses positioned in multiple hops.

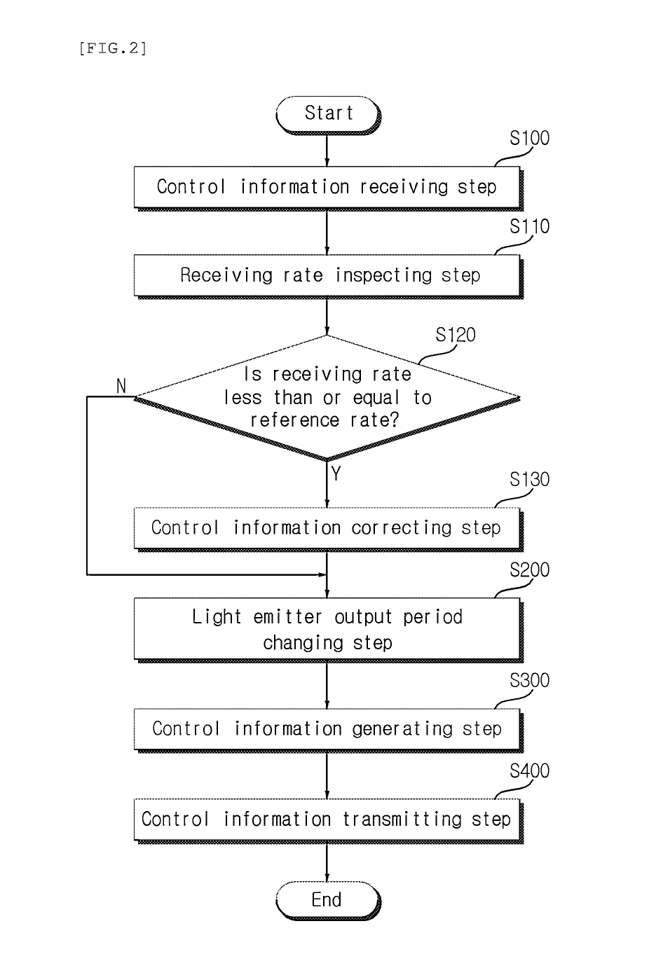

Describing an exemplary embodiment of the present invention with reference to FIG. 2, a method of controlling an inducement apparatus may include step S110 of inspecting a reception rate of received control information, rate comparison step S120 of determining whether the reception rate is less than or equal to a reference rate set by a user, and step S130 of correcting control information based on the result of rate comparison step S120.

In step S110 of inspecting the reception rate of received control information, when a transmission rate of the inducement apparatus is low, a data reception rate of control information received by the inducement apparatus is measured or inspected in order to correct the received control information.

In rate comparison step S120, whether the reception rate of received control information is less than or equal to the reference rate set by the user is determined. According to an exemplary embodiment of the present invention, when the reception rate of received control information is less than or equal to a pre-set reference rate, period information included in the control information may be insufficient for performing a control such as synchronization of the inducement apparatus. Accordingly, whether the period information is valid information to control the inducement apparatus is determined by comparing the preset reference rate and the reception rate of received control information. The reference rate indicates a minimum rate for validly processing the reception rate of received control information, and may be set based on a length of setting information and a setting information processing time of the inducement apparatus.

Step S130 of correcting control information is a step of correcting the control information when the reception rate of received control information is lower than the reference rate based on the result of rate comparison step S120. According to an exemplary embodiment of the present invention, in step S130 of correcting control information, it is possible to prevent a period start time from being delayed due to a low transmission rate by decreasing the period start time included in the control information by a correction time. According to an exemplary embodiment of the present invention, the correction time may be calculated according to Equation 1.

Correction time=Length of control information*Transmission time of one byte of control information [Equation 1]

In light emitter output period changing step S200, a setting associated with a flickering period of the light emitter is corrected based on a setting included in the received control information. Changing the flickering period of the light emitter indicates changing a flickering time such as a flickering start time, a flickering maintain time, and a flickering end time of the light emitter.

In control information generating step S300, the output period of the light emitter changed in light emitter output period changing step S200 is divided into a plurality of slots, and control information including the changed output period is generated as information for controlling another inducement apparatus in a random slot among the divided slots. According to an exemplary embodiment of the present invention, control information generating step S300 may include output period calculating step S330, period managing step S340, and period information generating step S350.

In output period calculating step S330, the output period of the light emitter is calculated based on an output setting of the light emitter changed in light emitter output period changing step S200. For example, when the light emitter is lit up for two seconds and is lit out for two seconds, the output period of the light emitter is calculated as four seconds. Alternatively, the output period of the light emitter may be calculated using a difference between lighting times of the light emitter.

In period managing step S340, a flickering period is divided into a plurality of slots based on the calculated output period. For example, when the output period is calculated as four seconds, and when the flickering period is divided into four slots, each individual slot has a one-second interval.

In period information generating step S350, a slot is randomly selected from among the plurality of slots generated in period managing step S340, and control information to be externally transmitted is generated in the selected slot. When generating control information, routing information of the inducement apparatus and a parameter such as a distance from a reference apparatus may be added to the control information. For example, in the case of randomly selecting a slot from among four slots, when a second slot is selected, transfer information is generated in a flickering period corresponding to the second slot.

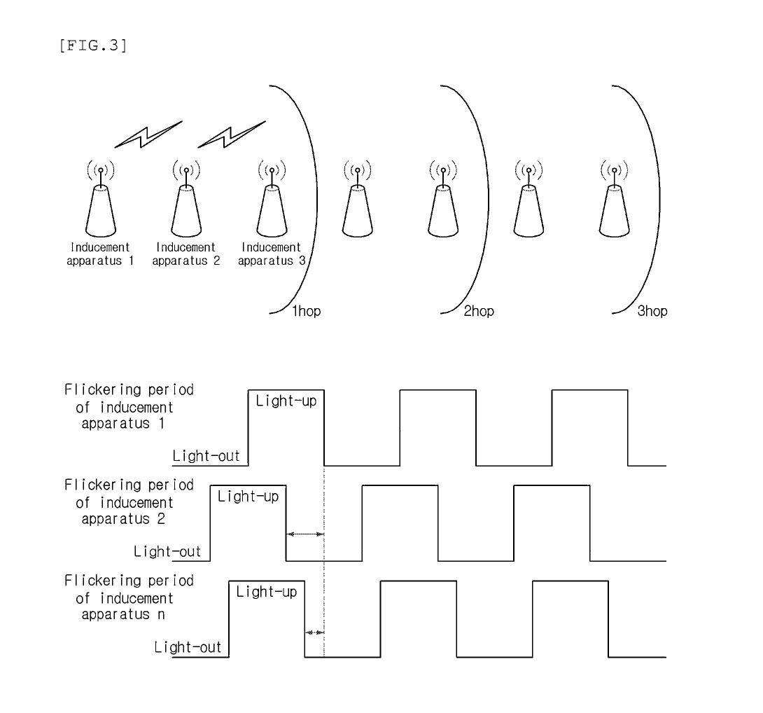

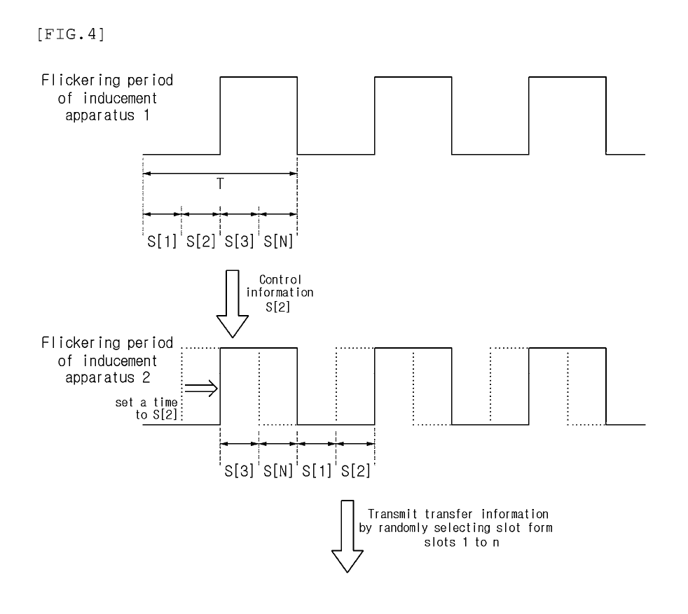

An exemplary embodiment of a method of controlling an inducement apparatus will be described with reference to FIGS. 3 and 4. FIG. 3 is an embodiment for a method of controlling an inducement apparatus according to a related art. Inducement apparatuses are linearly installed along the roads. The respective inducement apparatuses may communicate with each other using a communication technology. In the case of wireless communication, there are some constraints in respects to a distance due to a communication characteristic. Accordingly, there is a need for a protocol capable of forming a multi-hop network based on the distance constraint, and synchronizing apparatuses positioned in the multi-hop network.

In the conventional inducement apparatuses, in many cases, an internal timer is used as a flickering period of the inducement apparatus. Even though each of the inducement apparatuses repeats light-up/light-out at predetermined intervals, the flickering period is not synchronized.

FIG. 4 is a reference diagram illustrating a method of controlling a flickering period of an inducement apparatus according to an exemplary embodiment of the present invention. When a period in which the inducement apparatus repeats a light-up and a light-out is T, the number of slots to divide the period T is N, and an i-th slot belonging to the period T is S[i] (0<i≦N), a control signal generation apparatus selects a single slot S[i] in the light-out/light-up period T and transmits control information at a time corresponding to the selected slot during the flickering period.

Inducement apparatuses having received control information set a current time to S[i] and randomly select a single slot from among slots from 0 to N. When reaching the selected slot, an inducement apparatus that randomly selects the slot generates control information based on an output period of the inducement apparatus.

When an inducement apparatus that randomly selects the slot receives control information of another inducement apparatus having a hop further than the inducement apparatus prior to reaching the selected slot, the inducement apparatus does not generate control information and transmit the control information to the other inducement apparatus.

Describing an exemplary embodiment of controlling the overall network with reference to FIG. 4, when a slot 2 is selected from among slots 1 to N of an inducement apparatus 1, control information is accurately transmitted when an internal time of the inducement apparatus 1 reaches a time corresponding to the slot 2. Here, the control information includes slot information 2. When an inducement apparatus 2 receives the control information including the slot information 2, the inducement apparatus 2 immediately sets a time about a flickering period of the inducement apparatus 2 to the slot 2 and randomly selects a single slot from among slots 1 to N in order to transfer the control information to other inducement apparatuses that have not received the control information of the inducement apparatus 1. In the case of corresponding to the randomly selected slot during the flickering period, the inducement apparatus 2 transmits the control information. Transfer information may include additional information such as hop information and routing path information of the inducement apparatus 2 that has transmitted the received control information.

In general, when matching a flickering period in control information of an inducement apparatus, the main purpose is to match an accurate start point of a single period portion of a flasher with respect to the entire section as time synchronization. To transfer a flickering period start point of the conventional inducement apparatus to a neighboring hop, when it reaches a start point of a subsequent period portion, it is possible to inform a start point of a flickering period portion. In this case, when the whole inducement apparatuses are installed over a long distance and include a plurality of hops, an amount of time corresponding to (number of hops*flickering period) is used to control the entire section and thus, a time to complete control in the entire system is delayed.

Inducement apparatuses accumulate power of a battery using a solar heat and operate using the accumulated power. Therefore, when the entire control time uses a large amount of time, battery consumption may relatively increase.

Accordingly, as described above with reference to FIG. 4, when a synchronization time convergence is shortened by dividing a single period portion of an inducement apparatus into slots based on a predetermined time unit, it is possible to immediately recover the original flickering period by transmitting information about the short divided time.

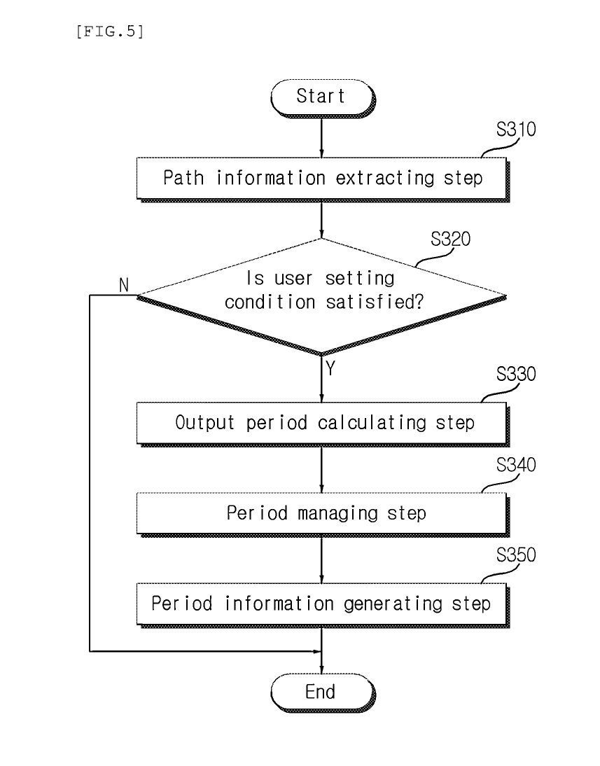

Describing another exemplary embodiment of the present invention with reference to FIG. 5, a transfer information generating step may include path information extracting step S310 and conditional information generating step S320.

In path information extracting step S310, path information is extracted from the received control information. The path information may be routing information included in the received control information and position information, and may include information such as a distance between the inducement apparatus and the reference apparatus, a transmission position of the control information, or a distance from an apparatus that has initially transmitted the control information.

In conditional information generating step S320, when the extracted path information corresponds to a preset condition, transfer information is generated.

According to an exemplary embodiment of the present invention, only when path information is extracted from received control information, and the extracted path information does not include destination information, control information may be generated. A destination path indicates a path including an inducement apparatus to be controlled by transmitting control information. A case where the destination path is included indicates a case where another inducement apparatus that is targeted to receive control information has already received control information and thus, there is no need to transmit the control information. Accordingly, a case where the destination path is not included corresponds to another inducement apparatus that is targeted to receive control information and thus, it is possible to generate control information.

According to another exemplary embodiment of the present invention, a travel path distance from a reference apparatus to an apparatus that has transmitted the received control information is extracted from the received control information. The travel path distance indicates a sum of distances constituting at least one path based on a path via which control information is transferred. When a distance from the reference apparatus exceeds the extracted travel path distance by comparing the path distance from the reference apparatus with the extracted travel path distance, control information may be generated.

The user may preset a condition about whether to generate information using the received control information. A hop, position information, distance information, time information, and information about communication specification may be set as parameters.

A step of generating control information may include output period calculating step S330, period managing step S34), and period information generating step S350, which is described above and thus, a further detailed description will be omitted here.

In control information transmitting step S400, the generated control information is externally transmitted. Control information transmitting step S400 may include a transmission rate inspecting step, a rate comparison step, and a control information correcting step.

The transmission rate inspecting step is to inspect a transmission rate of the inducement apparatus. Therefore, in the transmission rate inspecting step, communication specification such as a preset bandwidth and a transmission rate is measured.

In the rate comparison step, whether the measured transmission rate is less than or equal to a predetermined reference rate is determined.

When the transmission rate is less than or equal to the reference rate set by the user as a result of the rate comparison step, a period start time may be forward corrected by a correction time so that another inducement apparatus receiving control information may receive the control information at the reference rate, by preventing a delay that occurs due to the transmission rate.

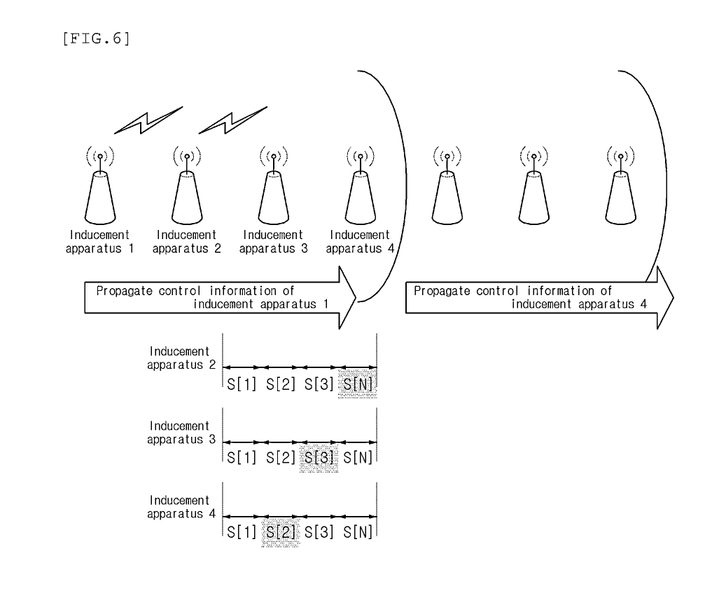

An exemplary embodiment of the present invention in a multi-hop environment will be described with reference to FIG. 6. Apparatuses 2 through 4 having received control information of an inducement apparatus 1 randomly select a single slot from slots 1 to N. In FIG. 6, the inducement apparatus 4 has selected the fastest slot S[2]. Accordingly, the inducement apparatus 4 may propagate control information earliest. As control information is transmitted, the inducement apparatuses 2 and 3 may receive control information of the inducement apparatus 4. In this case, since the inducement apparatus 4 positioned beyond positions of the inducement apparatuses 2 and 3, the inducement apparatuses 2 and 3 do not transmit control information.

On the contrary, when the inducement 2 or the inducement 3 initially transmits control information by including the control information in transfer information, the inducement apparatus 4 still has a duty to transmit control information. However, even in this case, when another inducement apparatus 5 or 6 having received control information of the inducement apparatus 2 or the inducement apparatus 3 transmits control information, the inducement apparatus 4 does not generate control information. Accordingly, a data collision within a network may be minimized, and control information may be transmitted to the overall network by decreasing the number of transmissions.

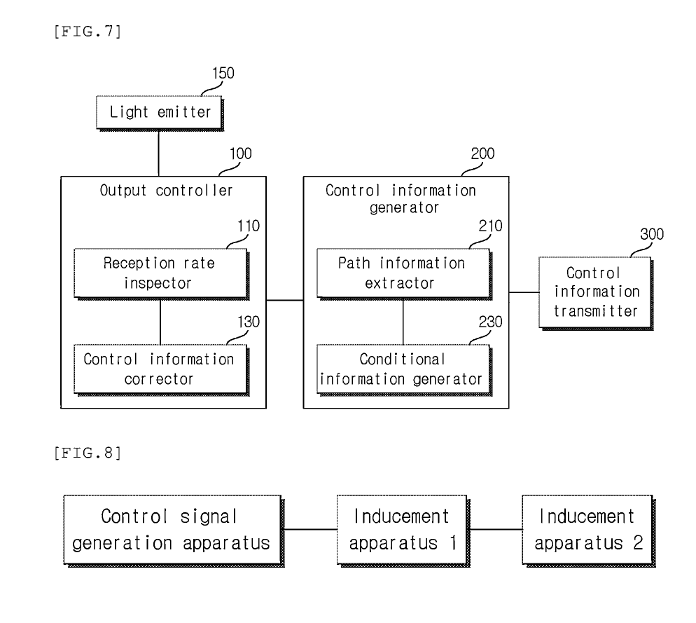

An inducement apparatus according to another exemplary embodiment will be described with reference to FIG. 7. The inducement apparatus may include an output controller 100, a light emitter 150, a control information generator 200, and a control information transmitter 300.

The output controller 100 receives control information from an external control signal generation apparatus and external inducement apparatuses. According to an exemplary embodiment of the present invention, the output controller 100 may include a reception rate inspector 110 and a control information corrector 130.

The output controller 100 receives control information from an outside and inspects a reception rate of the received control information using the reception rate inspector 110. When the reception rate is less than or equal to a reference rate set by a user, the control information corrector 130 corrects the control information. The reference rate indicates a minimum rate set to validly transfer content of the control information. For example, when the reception rate is less than or equal to the reference rate, the control information may be corrected by forward moving a period start time, included in the received control information, by the correction time.

The output controller 100 changes an output setting of the light emitter 150 based on the received control information. For example, the output setting of the light emitter may change at least one of a flickering period of the light emitter and a luminous level of the light emitter.

The control information generator 200 may generate control information based on the output period. According to an exemplary embodiment of the present invention, the control information generator 200 may include a period manager and a period information transmitter.

The period manager calculates an output period based on the changed output setting of the light emitter and divides the calculated output period into a plurality of slots. For example, when the light emitter is lit up for two seconds and is lit out for two seconds, the output period of the light emitter is calculated as four seconds. When N=4, each slot becomes to have a one-second time interval.

The period information generator randomly selects a slot from among the plurality of slots, and transmits control information to an outside at a time corresponding to the selected slot. For example, when a second slot is selected from among four slots, the period information generator transmits control information at a time corresponding to the selected second slot during a flickering period.

According to another exemplary embodiment of the present invention, the control information generator may further include a path information extractor 210 and a conditional information generator 230.

The path information extractor 210 extracts path information included in control information. The path information extracted from the path information may include routing information, position information of an apparatus having transmitted the control information, and a distance from a control signal generation apparatus. For example, the path information extractor 210 may extract a comparison target distance with respect to the control information. The comparison target distance may indicate a distance from the initial control signal generation apparatus.

When the extracted path information corresponds to a condition set by the user, the conditional information generator 230 generates transfer information. The condition set by the user includes a parameter that is comparable between a plurality of inducement apparatuses, such as a distance from the control signal generation apparatus and a hop.

For example, when a corresponding inducement apparatus is positioned in a far position by extracting the comparison target distance and by comparing the comparison target distance with the distance from the control signal generation apparatus, or when control information is received from an inducement apparatus that positioned in a hop beyond a position of the corresponding inducement apparatus by extracting path information and using hop information, transfer information is not generated. The conditional information generator 230 may include the aforementioned period manager and period information generator. A description relating thereto is made above and thus, a further detailed description will be omitted here.

A control system of an inducement apparatus according to an exemplary embodiment of the present invention will be described with reference to FIG. 8. The control system of the inducement apparatus may include at least one inducement apparatus and a control signal generation apparatus.

The control signal generation apparatus transmits control information and initially generates and transmits a control signal with respect to all the inducement apparatuses constituting the system according to a setting, a manipulation, or a control of a user. The control signal generation apparatus is not limited to a particular exemplary embodiment and an inducement apparatus may function as the control signal generation apparatus.

The inducement apparatus receives control information, changes an output period of a light emitter based on the received control information, divides the changed output period into a plurality of slots, and transmits, to another inducement apparatus, control information including the changed output period in a slot randomly selected from among the divided slots. At least one inducement apparatus may be included in the system.

The inducement apparatus may include a path extractor, an information controller, a reception rate inspector, and a control information corrector.

The path extractor extracts path information from the received control information.

When the extracted path information corresponds to a condition set by a user, the information controller changes the output period of the light emitter based on the received control information, divides the changed output period into the plurality of slots, generates control information, including the changed output period as control information for controlling another inducement apparatus in a slot randomly selected from among the divided slots, and transmits the generated control information to the other inducement apparatus.

The reception rate inspector inspects a reception rate of the received control information.

When the reception rate is less than or equal to a reference rate set by the user, the control information corrector may correct the received control information or may correct the generated control information.

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flickering memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method of controlling an inducement apparatus, the method comprising:
changing an output period of a light emitter of the inducement apparatus;
dividing the changed output period into a plurality of slots, and generating control information, including the changed output period, as control information for controlling another inducement apparatus in a random slot among the divided plurality of slots; and
transmitting the generated control information to the other inducement apparatus.

2. The method of claim 1, wherein the changing of the output period of the light emitter changes the output period of the light emitter based on the control information received from the inducement apparatus.

3. The method of claim 2, wherein the generating of the control information comprises:
extracting path information from the received control information; and
generating the control information when the extracted path information does not include destination information.

4. The method of claim 2, wherein the generating of the control information comprises:
extracting, from the received control information, a travel path distance from a reference apparatus to an apparatus that has transmitted the received control information; and
generating the control information when a path distance from the reference apparatus exceeds the extracted travel path distance.

5. The method of claim 2, wherein the changing of the output period of the light emitter based on the received control information comprises:
determining whether a reception rate of the received control information is less than or equal to a predetermined reference rate; and
decreasing a flickering period start time of the received control information by a correction time when the reception rate is less than or equal to the predetermined reference rate.

6. The method of claim 1, wherein the generating of the control information comprises:
determining whether a transmission rate of the eye inducement apparatus is less than or equal to a predetermined reference rate; and
decreasing a flickering period start time of the generated control information by a correction time when the transmission rate is less than or equal to the predetermined reference rate.

7. The method of claim 2, wherein the received control information is received by the inducement apparatus using wireless communication.

8. The method of claim 7, wherein a period start time of the received control information is decreased using a correction time by determining a transmission rate and a transmission distance of the wireless communication.

9. An inducement apparatus, comprising:
an output controller to change an output period of a light emitter;
a control information generator to divide the changed output period into a plurality of slots, and to generate control information, including the changed output period, as control information for controlling another inducement apparatus in a random slot among the divided plurality of slots; and
a control information transmitter to transmit the generated control information to the other inducement apparatus.

10. The inducement apparatus of claim 9, wherein the output controller changes the output period of the light emitter based on the received control information.

11. The inducement apparatus of claim 10, wherein the control information generator comprises:
a path information extractor to extract path information from the received control information; and
a condition information generator to generate the control information when the extracted path information does not include destination information.

12. The inducement apparatus of claim 10, wherein the control information generator comprises:
a path information extractor to extract, from the received control information, a travel path distance from a reference apparatus to an apparatus that has transmitted the received control information; and
a conditional information generator to generate the control information when a path distance from the reference apparatus exceeds the extracted travel path distance.

13. The inducement apparatus of claim 10, wherein the output controller comprises:
a reception rate inspector to inspect a reception rate of the received control information;
a control information corrector to decrease a flickering period start time of the received control information by a correction time when the reception rate is less than or equal to a reference rate set by a user; and
a period changing unit to change the output period of the light emitter based on control information processed by the control information corrector.

14. An inducement system, comprising: a plurality of inducement apparatuses,
wherein each of the plurality of inducement apparatuses receives control information, changes an output period of a light emitter based on the received control information, divides the changed output period into a plurality of slots, generates control information, including the changed output period, as control information for controlling another inducement apparatus in a random slot among the divided plurality of slots, and transmits the generated control information to the other inducement apparatus.

15. The inducement system of claim 14, wherein each of the plurality of inducement apparatuses comprises:
a path extractor to extract path information from the received control information; and
an information controller to change the output period of the light emitter based on the received control information when the extracted path information corresponds to a condition set by a user, to divide the changed output period into the plurality of slots, to generate the control information, including the changed output period, as the control information for controlling the other inducement apparatus in the random slot among the divided plurality of slots, and to transmit the generated control information to the other inducement apparatus.

16. The inducement system of claim 15, wherein each of the plurality of inducement apparatuses further comprises:
a reception rate inspector to inspect a reception rate of the received control information; and
a control information corrector to correct at least one period start time of the received control information and the generated control information when the reception rate is less than or equal to a reference rate set by a user.
